(19) United States
(12) Patent Application Publication
(10) Pub. No.: US 2002/0166254 A1
(43) Pub. Date: Nov. 14, 2002

(54) Method and apparatus for preparing custom-fitted clothing

(75) Inventor: Gabriel S.A. Liebermann, Narberth, PA (US)

Correspondence Address: MORGAN LEWIS & BOCKIUS LLP, 1111 PENNSYLVANIA AVENUE NW, WASHINGTON, DC, 20004, US

(73) Assignee: Intellifit, Inc.

(21) Appl. No.: 10/133,637

(22) Filed: Apr. 29, 2002

Related U.S. Application Data
(63) Continuation-in-part of application No. 09/257,573, filed on Feb. 25, 1999, now Pat. No. 6,415,199.

(51) Int. Cl. G01B 3/10

(52) U.S. Cl. 33/759

(57) ABSTRACT

A stretch bodysuit is provided which allows precise measurements of the proportions of the portion of the body enclosed by the bodysuit. Specific benchmarks and lines are positioned at key locations on the bodysuit. These benchmarks and lines may be aligned with or positioned to coincide with critical measuring points such as joints or other bodily features. The benchmarks act as a guide for using a tape measure. Alternatively, the bodysuit and the lines and benchmarks thereon may be produced in such a fashion as to facilitate optical scanning of the suit. An apparatus for acquiring custom measurements is provided and includes a flexible measuring tape having a nub, and a rigid tab removably engaged with the nub. Once the dimensions have been recorded, a computer program uses the dimensions to generate a pattern for the desired garment.

This application is a continuation-in-part of U.S. patent application Ser. No. 09/257,573 filed Feb. 25, 1999, the content of which is relied upon and incorporated by reference.

### BACKGROUND OF THE INVENTION

1. Field of Invention

The invention relates generally to custom-fitted clothing, and, more particularly to apparatus for, and methods of, acquiring the dimensions of a portion of a human body.

2. Description of Related Art

It has long been a goal of the garment industry to provide custom-fit or made-to-measure clothing on a mass level. Of course, custom-tailored clothing has long been available to those who can afford the high cost of having a tailor measure the dimensions of their body and produce, through a series of fittings and additional measurements, clothing that is customized to fit to their exact dimensions. However, with the advent of catalog and Internet shopping, a significant need has arisen in the garment industry to acquire accurate measurements directly from the customer in order to find the proper ready-to-wear item or to either alter or make a garment to order.

The difficulty in providing more extensive access to custom-tailored clothing is twofold. First, it is difficult to obtain the precise measurements of the customer's physical dimensions without consuming substantial amounts of the seller's time. Thus, in order to obtain the measurements, a seller must have a large staff capable of taking and recording a multitude of exact measurements of the customer's body. Such a large staff dramatically increases the seller's overhead costs. These costs are, of course, transferred to the buyer, increasing the cost of the clothing, often to a degree prohibitive to most customers.

Second, once a set of exact measurements is obtained, the tailor must construct a set of patterns based on those measurements which fit the customer well by allowing for freedom of movement of the customer's limbs. Traditionally, a tailor works with a muslin pattern based on the original measurements and, through at least one iteration, i.e., the fitting, adjusts the measurements' to account for freedom of movement. Thus, the customer must visit the tailor for at least two sets of measurements, the original set and the fitting, before he or she can expect to receive the finished garment. Not only are the costs of the garment increased due to the expense of providing a tailor to perform the fitting, but the customer is inconvenienced as a result of the need to appear at least twice at the seller's outlet.

Apart from time and cost considerations, custom-tailoring is a very invasive process involving a great deal of contact, often uncomfortable, between the tailor and the buyer. The invasion of privacy inherent in the custom-tailoring process discourages many potential buyers.

Numerous methods of automating the measurement and pattern-producing process have been proposed. For example, U.S. Pat. No. 4,293,959 discloses a stretch bodysuit to which muslin panels are attached in order to create patterns for clothing which will perfectly fit the wearer of the bodysuit. While this approach effectively produces patterns for custom-fitted clothing, it still requires custom application of muslin panels to the wearer—a time-consuming and inefficient process. Similarly, the Levi's Corporation has introduced a “custom-fit” program for providing custom-fitted trousers to customers. In reality, this program merely provides a very large number of model trousers, as many as 400 in a given location, from which the buyer selects the trousers which fit most closely to his or her body. While this approach does not require the presence of an expert tailor to perform a fitting, the process of selecting the appropriate trousers may still be time-consuming. Furthermore, maintaining a trial inventory of up to 400 trousers at the retail outlet may be a substantial burden to the seller.

Consequently, it is desirable to provide a method for rapidly, accurately, and privately taking the precise measurements of a buyer's bodily dimensions. It is further desirable to provide a means for measuring the buyer's dimensions once, and producing a custom pattern from which garments may be produced without the need for additional measurements or fittings. To accomplish this goal, it is important to eliminate as many potential errors in the measurement acquisition process as possible. It is also desirable to provide a measuring system whereby the user can continuously update existing measurements and take new ones if needed.

### SUMMARY OF THE INVENTION

The invention overcomes the drawbacks and disadvantages of the prior art by providing a means for rapidly, accurately, and privately taking precise measurements of a person's bodily dimensions. In particular, the invention accomplishes this by providing a measurement acquisition system including a stretch bodysuit marked so as to allow for precise measurements of portions of the body enclosed by the bodysuit. Specific benchmarks are located at key points in the bodysuit which are aligned with or positioned to coincide with critical measuring points, such as joints or other body features. The benchmarks act as guidelines for placing a tape measure or other measuring device on the body to determine the dimensions required to fit a garment, such as the circumference of the waistline, thigh, seat, and other relevant dimensions. A series of lines interconnect the benchmarks to provide similar guidance for measuring inseams, outseams, sleeve lengths, and other equally important dimensions. The tape measure used with the suit may include a rigid extension upon which the customer stands and/or a sliding indicator in order to simplify and improve the accuracy of the measurement acquisition process.

Alternatively, the bodysuit and the lines and benchmarks thereon may be produced in such a fashion as to facilitate optical scanning of the suit. A computer program is then provided which analyzes the scanned image and determines the critical measurements. In another embodiment, the bodysuit may contain sensors incorporated directly therein that generate a signal corresponding to the desired measurements. The customer's measurements can thus be determined automatically, without the need for time-consuming manual measuring. In yet another embodiment, elastic bands positioned along critical measurement locations are marked in such a manner that the deformation of the elastic band, which is proportional to the measurement being taken, distorts the markings such that a marking corresponding to the accurate measurement of the particular body part is visibly distinct from the other markings.

Other embodiments of the invention allow for accurate measurement acquisition without the use of the bodysuit. One such embodiment provides for direct application of adhesive measuring tape to the customer's skin or undergarment. In another embodiment, numbered labels indicating the corresponding body part name are adhered to the customer's skin or undergarment to guide the user in taking the critical measurements.

In yet another embodiment, an apparatus for acquiring custom measurements of the dimensions of a portion of a human body is provided. The apparatus may include a flexible measuring tape having a nub attached to one end, and a rigid tab removably engageable with the nub. The apparatus may also include a measurement indicator slideably engageable with the measuring tape. The measurement indicator may be located approximately at a graduated marking labeled 0, when the rigid tab is removed and the indicator is approximately adjacent to the nub. An end portion of the measuring tape may be insertable through the indicator for measuring the circumference of the portion of a human body.

In yet another embodiment, a method of acquiring measurements of the dimensions of a portion of a human body, using a custom measurement apparatus, is provided. The apparatus may have a flexible measuring tape with a nub attached to an end, and a rigid tab removably engageable with the nub. The method may include the steps of standing on the rigid tab while measuring the elevation of a portion of the body with the flexible measuring tape, removing the rigid tab, and measuring the circumference of the portion of the body with the flexible measuring tape. The method may further include the step of entering the elevation and circumference into a database via the internet. The step of measuring the circumference of the portion of the body may include the steps of sliding an indicator approximately adjacent to the nub so that the indicator is approximately adjacent to a marking of 0 on the measuring tape, wrapping the measuring tape around the portion of the body; and inserting an end of the measuring tape through the indicator to read a marking on the measuring tape. The steps of measuring the elevation and the circumference may further include the step of applying at least one marker to the body or an article of clothing on the body, in accordance with a visual display of text or graphics which describes to a user how to properly position the marker.

Once the dimensions have been recorded, either automatically or manually, a computer program uses the dimensions to generate a pattern for the desired garment. The program may be resident on the user's computer. Alternatively, the user may transmit the dimensions to the central facility, whereupon a computer program at the central facility creates the pattern and directs the textile machinery to produce the garment.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is front view of a stretch bodysuit in accordance with the present invention.

FIG. 2 is a perspective view of a first alternate embodiment of the stretch bodysuit of FIG. 1.

FIG. 3 is a front view of the bodysuit of FIG. 2.

FIG. 4 is a side view of the bodysuit of FIG. 2.

FIG. 5 is a plan view of a crosshair for use on a bodysuit in accordance with the present invention.

FIG. 6 is a plan view of an alternative embodiment of the crosshair of FIG. 5.

FIG. 7 is a plan view of another alternative embodiment of the crosshair of FIG. 5.

FIG. 8 is a plan view of yet another alternative embodiment of the crosshair of FIG. 5.

FIG. 9 illustrates a graphical user interface (GUI) of a software application in accordance with the present invention.

FIG. 10 is a functional diagram illustrating an integrated custom-fit apparel system in accordance with the present invention.

FIG. 11 illustrates an electronic dimension acquisition system in accordance with the present invention.

FIG. 12 is a front view of a second alternate embodiment of the bodysuit of FIG. 1.

FIG. 13 illustrates a dimensional sensor for use in the bodysuit of FIG. 12, shown in the relaxed position.

FIG. 14 illustrates a dimensional sensor for use in the bodysuit of FIG. 12, shown in the stretched position.

FIG. 15 illustrates the use of the tape measure to take elevation measurements.

FIG. 16 illustrates benchmarks consisting of figures instead of lines.

FIG. 17 illustrates a measurement acquisition system without the use of the bodysuit.

FIG. 18 shows the various labels for adherence to the critical body parts as indicated in FIG. 17.

FIG. 19 illustrates a roll of adhesive measuring tape.

FIG. 20 demonstrates the proper location at which to detach the measuring tape.

FIG. 21 demonstrates the proper creasing of the measuring tape.

FIG. 22 demonstrates adhering the tape stubs to the measurement form.

FIG. 23 is a perspective view of another embodiment of a measuring device component of the invention.

FIG. 24 is a perspective view of another embodiment of a flexible measuring tape of the invention.

FIG. 25 is a perspective view of another embodiment of a measurement indicator of the invention.

FIG. 26 illustrates adhering markers to clothing in accordance with principles of the invention.

FIG. 27 illustrates the measurement indicator of FIG. 25 and the flexible measuring tape of FIG. 24 being prepared to measure a circumference.

FIG. 28 illustrates a circumference being measured in accordance with principles of the invention.

FIG. 29 illustrates an elevation being measured in accordance with principles of the invention.

FIG. 30 illustrates a back view of a rise being measured in accordance with principles of the invention.

FIG. 31 illustrates a front view of the rise being measured of FIG. 30.

### DETAILED DESCRIPTION OF THE PREFERRED EMBODIMENTS

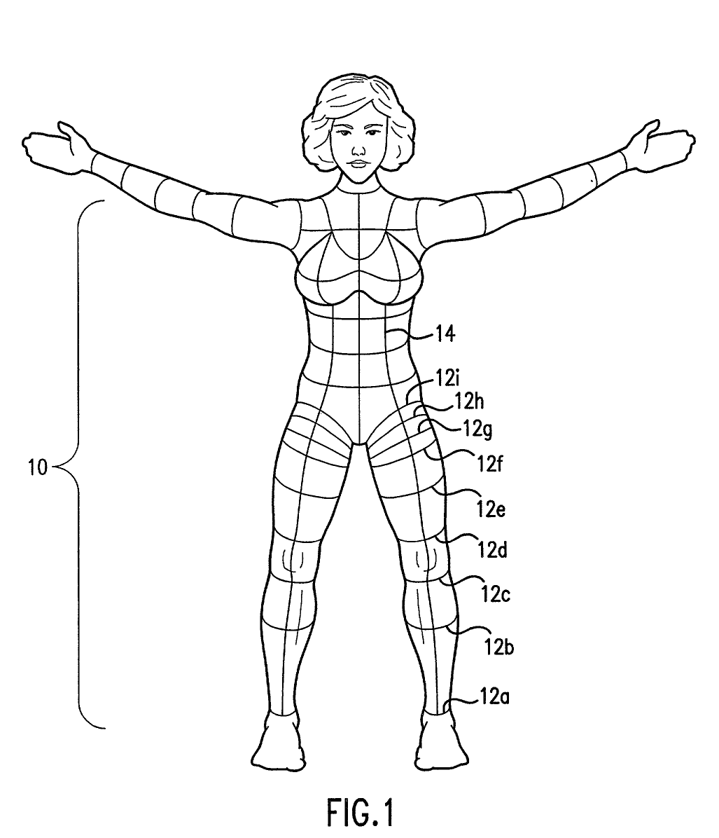

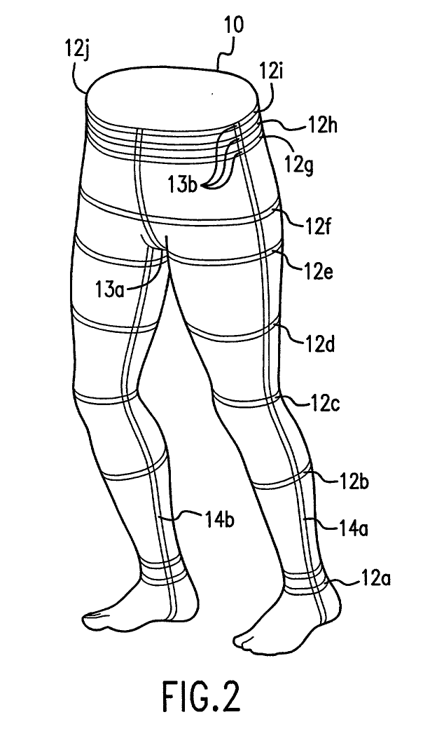

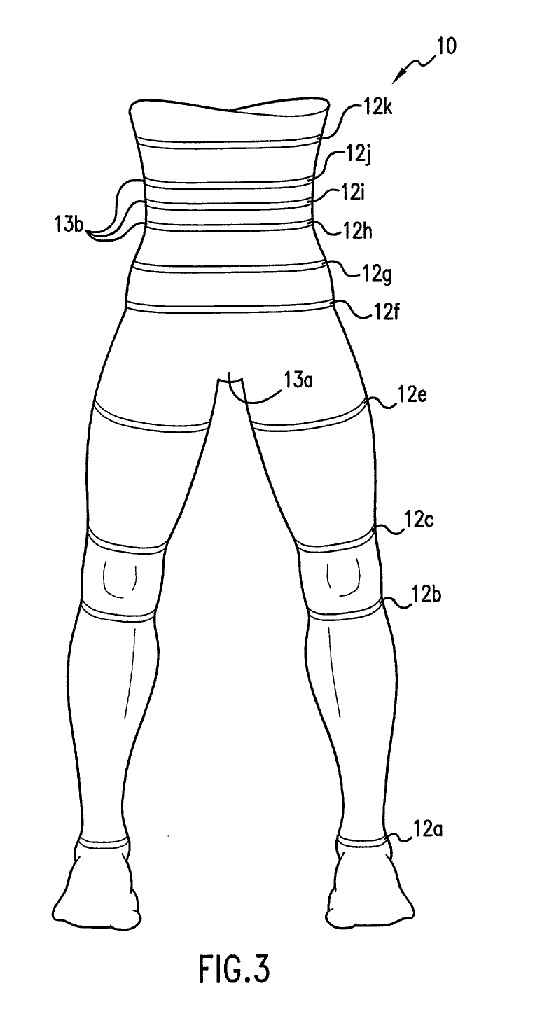

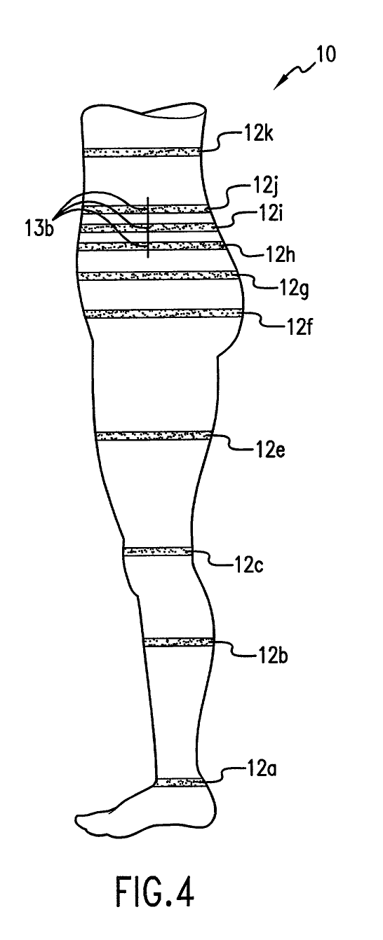

FIGS. 1-8 illustrate a bodysuit 10 in accordance with the present invention. Bodysuit 10 is made of lycra™, nylon or any other suitable stretchable fabric that tightly conforms to the shape of the portion of a body which it encloses. FIG. 1 illustrates a bodysuit 10 which encloses the entire body of the user; however, partial bodysuits, as shown in FIGS. 2-4, may be provided which enclose only portions of the body, such as the legs. Other partial bodysuits (not shown) may be provided for covering only, the torso or any other portion of the body for which garments may be made.

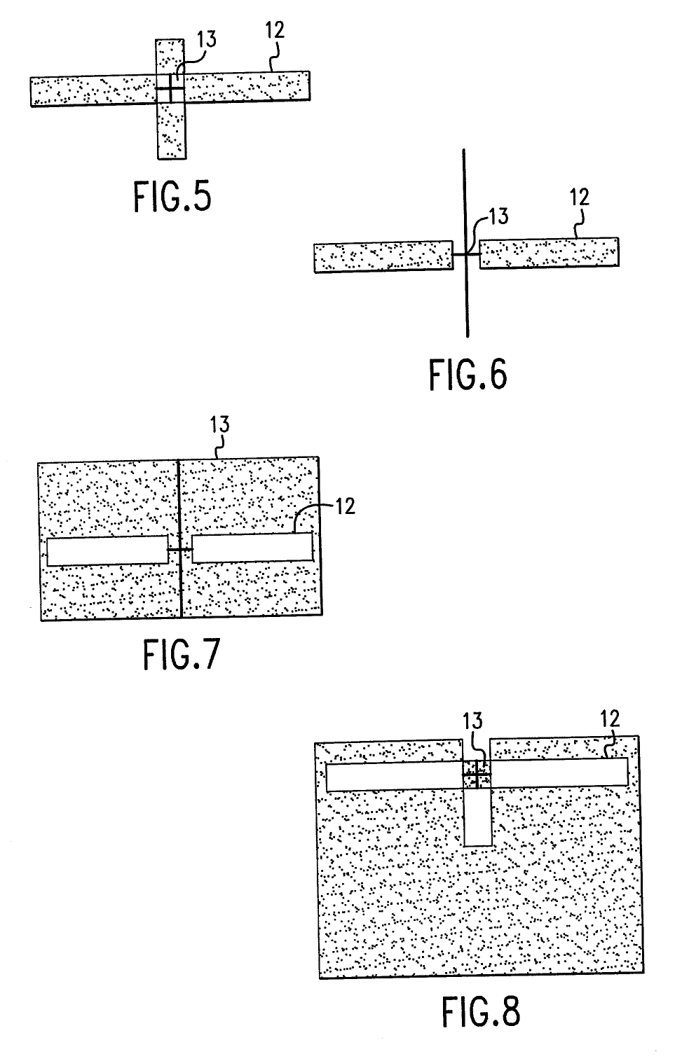

Bodysuit 10 is marked with a plurality of benchmarks 12a-n, in which “n” is variable and may be selected as desired or appropriate to provide sufficient benchmarks to allow the proper positioning and measuring as described below. Benchmarks 12a-n may be removable or permanent. For example, benchmarks 12a-n may be applied by printing, dyeing, weaving, stitching or otherwise affixing them to the fabric of bodysuit 10. Benchmarks 12a-n may be bars, stripes, lines, dots or any other suitable means for highlighting specific locations on bodysuit 10. Referring to FIGS. 5-8, benchmarks 12a-n may be labeled with identifying crosshairs 13, which, as described in more detail below, assist the user in taking measurements and, moreover, will allow an optical scanner to differentiate the different benchmarks 12a-n.

Benchmarks 12a-n are positioned to reflect the measuring points necessary to create or modify patterns for a particular garment. For instance, referring to FIGS. 2-4, if measurements are being taken for pants or trousers, benchmarks 12a-n are positioned at the hips (12f, g), ankles 15 (12a), waist (12h-j), knees (12c), and other relevant locations.

Referring to FIG. 1, a plurality of reference lines 14 may interconnect benchmarks 12a-n. Reference lines 14 are provided along dimensions typically measured for the production of garments and garment patterns. For instance, reference lines 14 may be provided along the inseam, outseam, sleeve (not shown), and other relevant locations.

A customer or salesperson selects a bodysuit 10 that corresponds to the garment for which the customer is being fitted. For example, if the customer desires trousers, a bodysuit 10 as shown in FIGS. 2-4 which covers only the lower torso and legs may be selected. The customer puts on bodysuit 10 and aligns benchmarks 12a-n to correspond with the specific measuring points, such as joints or other bodily features. For instance, to be fitted for trousers, a customer puts on bodysuit 10 and, depending on the type of trouser desired, aligns one of benchmarks 12i-j with his or her waistline. Benchmarks 12g, e, b and a are aligned with the widest parts of the seat, thigh, knee, and ankle, respectively.

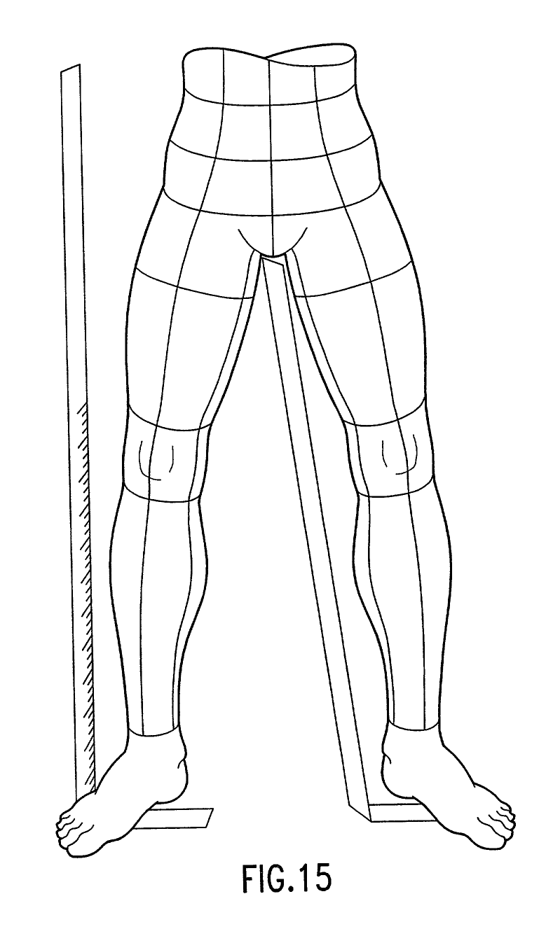

When taking measurements manually, the customer or salesperson uses a tape measure to measure both the elevation and circumference of critical measuring points. The tape measure of the preferred embodiment has a rigid end and/or sliding indicator. The rigid end allows the user to stand on the rigid portion, as shown in FIG. 15, and measure the critical elevations. In addition, the rigid end allows the user to take the full or partial rise measurement without assistance. The user simply secures the rigid end into the waistband at the back of the bodysuit and pulls the tape between his or her legs up to the front of his or her waist. The rigid end can be made from a variety of rigid materials, including but not limited to wood, plastic, or metal. The sliding indicator is preferably made from plastic or metal, although any suitable material may be used. One embodiment of the tape measure provides a tape with thousands of tiny dots printed on it. The sliding indicator has a complementary pattern whereby upon sliding the indicator along the tape, the relevant measurements are displayed by virtue of the resulting interference pattern. In yet another embodiment, the sliding indicator has an electro-optical encoder and a liquid crystal display (LCD) so that as the indicator is positioned along the tape, the LCD displays the appropriate measurement. While the above-mentioned tape measures would provide more accurate measurements, a normal tape measure can nonetheless also be used.

The customer first inserts the tape measure through the sliding indicator, similar to how one inserts a belt through a buckle. As shown in FIG. 15, the customer then steps on the rigid end of the tape measure, extends the tape to the correct height as indicated by the benchmarks on the suit, and positions the sliding indicator at that appropriate elevation. For instance, the customer or salesperson measures the inseam and outseam, e.g., by having the customer step on one end of a tape measure and measuring the distance along reference lines 14a and 14b from the floor to crosshairs 13a and 13b, respectively (FIG. 2). Use of the sliding indicator results in more accurate measurements as it allows the user to position the indicator at the correct height on the tape measure, step off of the tape measure if he or she desires, and read the measurement. This alleviates the customer's straining to read the measurement while still standing on the tape or, even worse, using a finger to mark the correct measurement, methods that may jeopardize measurement accuracy.

The customer then measures the circumference of each relevant body part, using the respective benchmarks as a guide to properly placing the tape measure. For example, to measure the customer's upper thigh, the customer measures the circumference of benchmark 12e (FIGS. 2-4). The salesperson or customer inserts one end of the tape measure through the sliding indicator, fashioned like a belt buckle, and positions the tape around the thigh in alignment with benchmark 12e. The sliding indicator is then positioned at the correct measurement. Once again, the indicator eliminates potential measurement error by obviating the need for the user to hold the two ends of the measuring tape together by hand. Moreover, the indicator enables a salesperson to accurately read the measurement without touching the customer, thus lessening the invasiveness of the process.

It is vital to the proper fit of the resulting garment that the circumference of the body part (the upper thigh in this example) be measured at the precise point where the elevation measurement was taken. The present invention, with its benchmarks and reference lines, guides the user in measuring circumferences that directly correspond to elevations and vice versa.

Measurements may be taken directly from a single benchmark; by reference to two or more benchmarks, reference lines or crosshairs; or by reference to one or more benchmarks and other reference points, such as the floor. Benchmarks 12 and reference lines 14 may include fastening means, such as hook and loop fasteners, which allow a tape measure to be removable affixed to bodysuit 10.

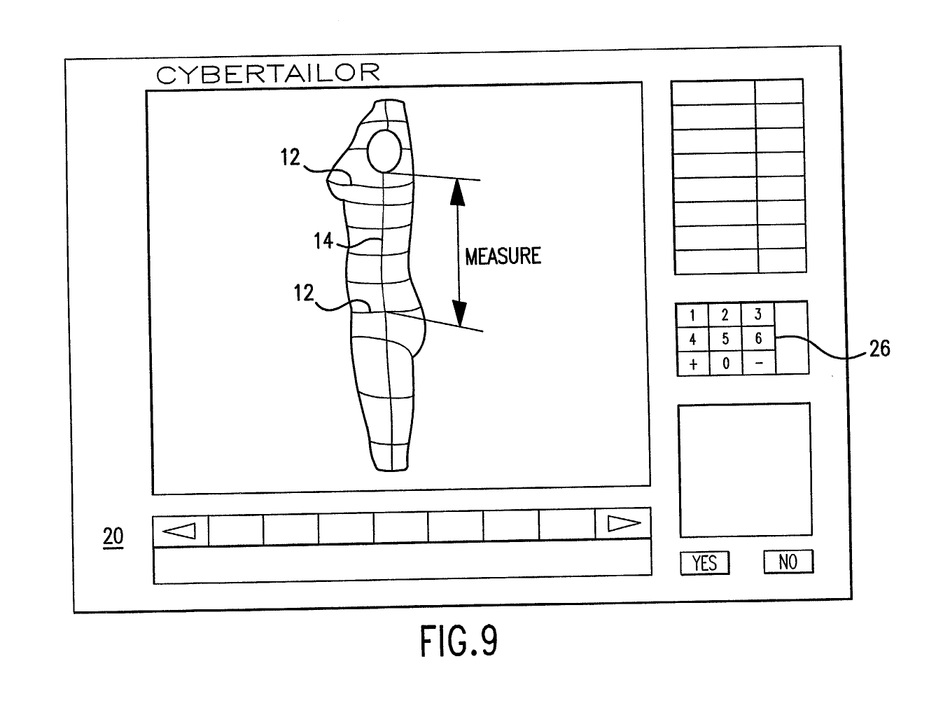

Correct adjustment or application of benchmarks 12a-n may be directed by a salesperson who is trained in the use of the garment and familiar with the measurements required for garment production. Alternatively, the adjustments may be made by the customers themselves or by the salesperson based on detailed written instructions. Alternatively, as shown in FIG. 9, the user may be prompted by computer software which displays instructions on a display screen or monitor of a computer 20. The computer software may be a conventional Windows-based or other application which uses a graphical interface to guide or prompt the user in the proper application and adjustment of bodysuit 10. Moreover, input fields 26 may be provided, which allow the user to input (if necessary) measured dimensions into a database for use as described below. The dimensions may be input into the database by means of a keypad (not shown) or other data input mechanisms, such as a mouse.

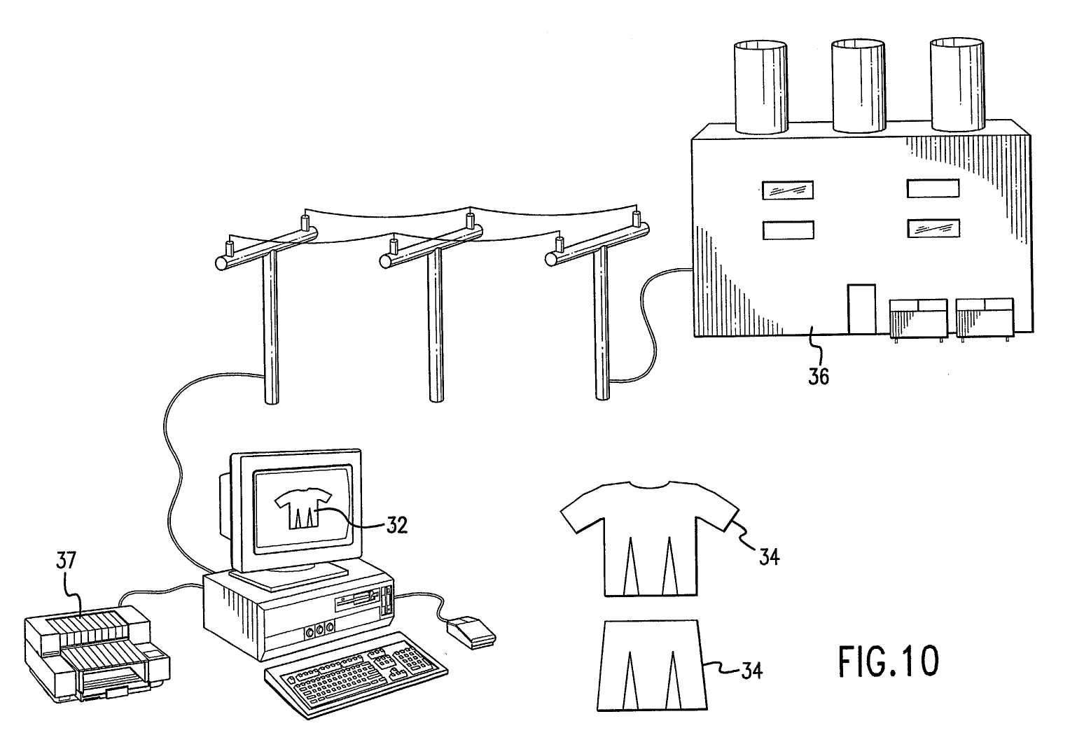

From the measured dimensions of the enclosed portion of the body, a computer application resident on computer 20 can generate a custom fitted pattern 34 for the desired garment. As shown in FIG. 10, pattern 34 can be printed out on a printer 37 for the customer. Alternatively, the measurements may be transmitted directly to clothing manufacturer 36 whereupon pattern generation software resident on computers at the manufacturing site may then generate the desired patterns 34.

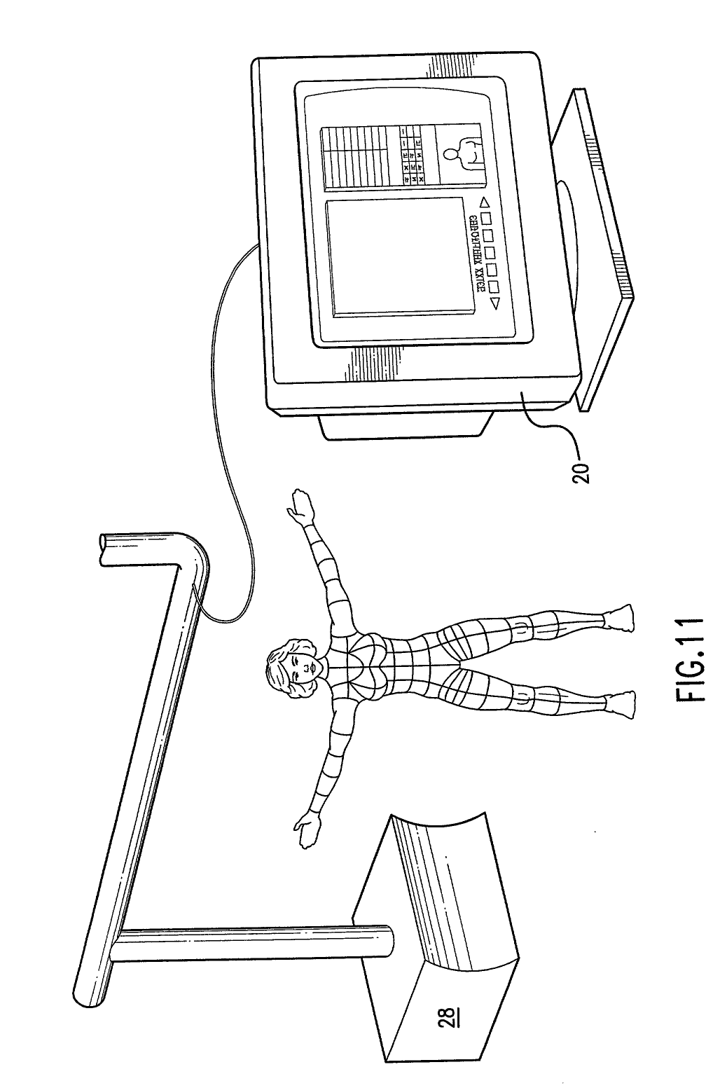

In alternative embodiments, the measurements of bodysuit 10 may be acquired directly from bodysuit 10 by computer 20. For example, as illustrated in FIG. 11, an optical scanner 28 may be used to acquire a scanned image of the bodysuit 10. Any appropriate optical scanning method or mechanism may be used. Computer 20 then uses optical image manipulation software to determine the critical measurements of the scanned image. One such scanning system, the Body Measurement System (“BMS”) produced by [TC]² is designed to scan a body and extract the critical measurements from the raw scan data. More information about BMS is available at www.TC2.com.

The bodysuit facilitates the computer's identification of the critical areas to be measured. As explained above, the user of the suit adjusts the suit so that the benchmarks and reference lines coincide with the critical measurement areas. In the preferred embodiment, the benchmarks and reference lines are white. By properly calibrating the cameras on the scanner, the scanner can be set to read or scan only white images, i.e., the benchmarks and reference lines on the suit. Therefore, the scanner only captures and transmits images of the critical areas. The computer then determines the measurements from these images.

Differences in the crosshairs at the intersections of the benchmarks and reference lines, as shown in FIGS. 5-8, enable the computer to differentiate between the different benchmarks and associate the correct measurement with the correct benchmark. For example, in FIG. 2, benchmark 12a, located at the ankle of bodysuit 10, may have a crosshair 13 as shown in FIG. 5, whereas benchmark 12c, located at the knee, has a crosshair 13 as shown in FIG. 6. These crosshairs 13 are designed to be distinguishable by an optical scanning unit and allow the measuring system to differentiate between benchmarks 12a and 12c. As shown in FIGS. 5-8, one possible way of distinguishing the different crosshairs is to use a different square matrix configuration for each one. Once the correct measurements are calculated, the measurements may then be downloaded to a database for use by the pattern generating software.

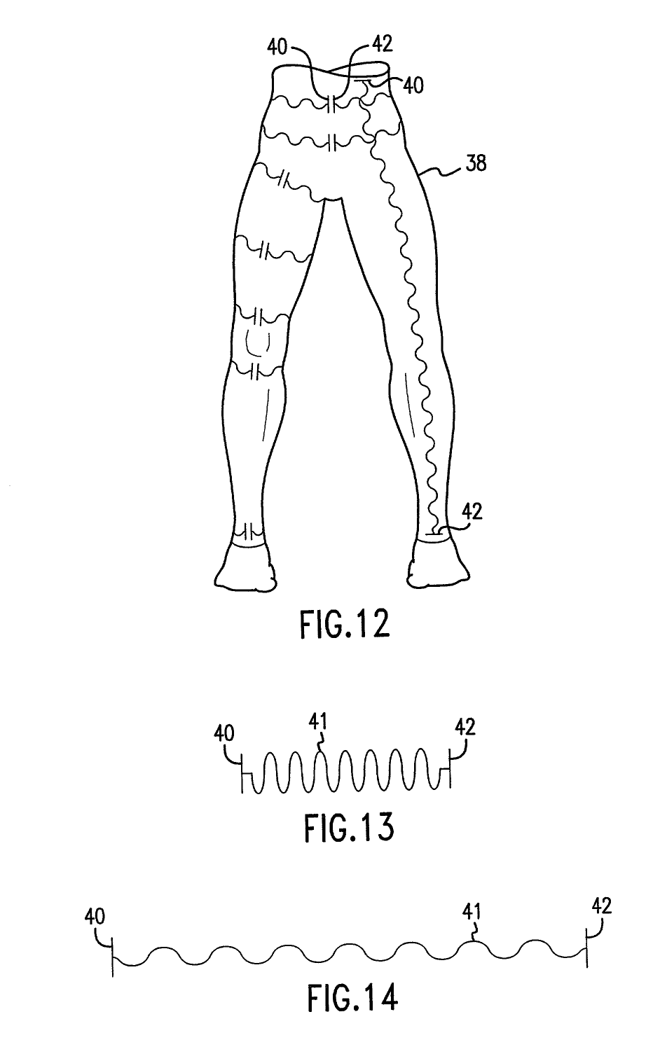

Alternatively, as shown in FIGS. 12-14, measurements may be electronically acquired through sensors 38 incorporated directly into bodysuit 10. Any appropriate sensor capable of generating a signal proportional to the measurement between two points on bodysuit 10 may be employed. For example, sensor 38 may include a conducting fiber or guide 41, emitter 40, and detector 42. The signal emitted by emitter 40 can be electrical, optical, acoustic, or any other suitable signal. The signal travels through guide 41 and is received by detector 42. The strength of the signal detected by detector 42 is related to the distance between emitter 40 and detector 42 and is determined through conventional signal processing techniques.

To measure the dimensions of a portion of a customer's body using sensor 38, the customer would enclose the portion of his or her body in bodysuit 10, which has at least one sensor 38 attached to the suit. Sensor 38 may communicate with a computer or other data recording device. For instance, detector 42 may transmit a microwave, infrared or other radio frequency signal to a receiver on the computer. Software resident on the computer determines the dimensions of the enclosed portion of the body based on the data received from detector 42. The dimensions may then be used in one of the ways described above.

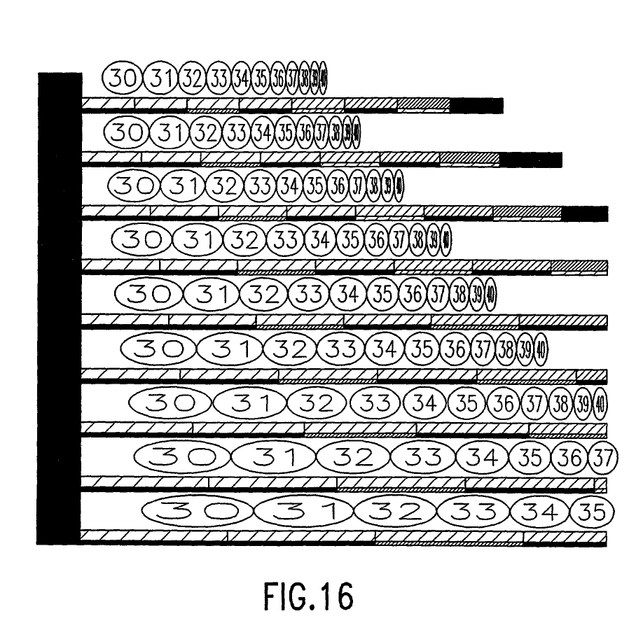

Alternatively, as shown in FIG. 16, the benchmarks and reference lines of the invention can consist of elastic bands that are marked in such a manner that the stretching of the elastic band that results when the user dons the suit distorts the markings such that a marking corresponding to the correct measurement is visibly distinct from the other markings. For example, as shown in FIG. 16, the benchmarks, instead of being solid lines, may consist of consecutive circle-like figures containing numbers that represent measurements. When the user properly adjusts the suit to align the benchmarks with the critical areas of the body, the shape of all but one of the circle-like figures distorts. One circle-like figure will instead form a perfect circle. The number in this circle indicates the correct measurement of that body part. For each benchmark, the user can visually determine which figure indicates the correct measurement. In this case, the-user can identify which circle-like figure of each benchmark forms a perfect circle when the suit is on the user, thus indicating the correct measurement of each critical body area. Alternatively, a scanning system can also gauge the correct figure and thus precise measurement of the body part.

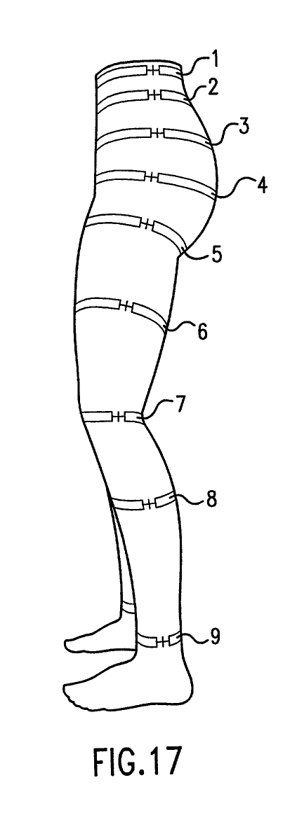

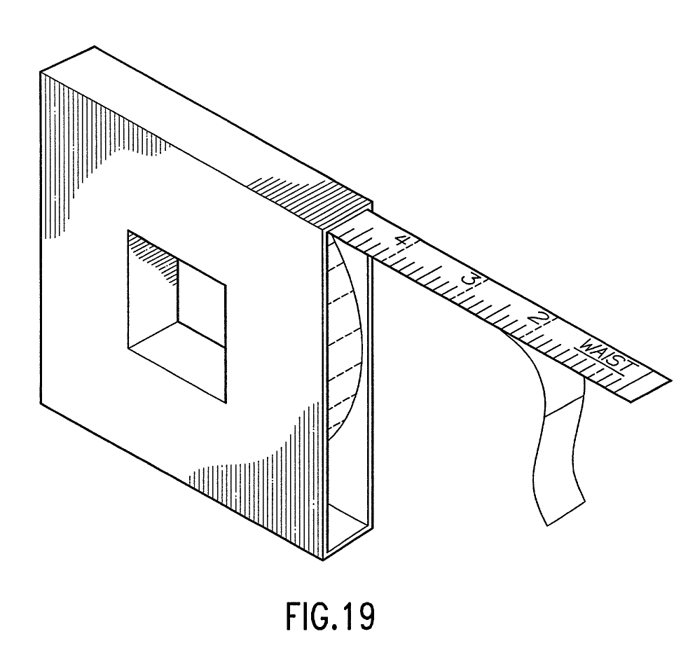

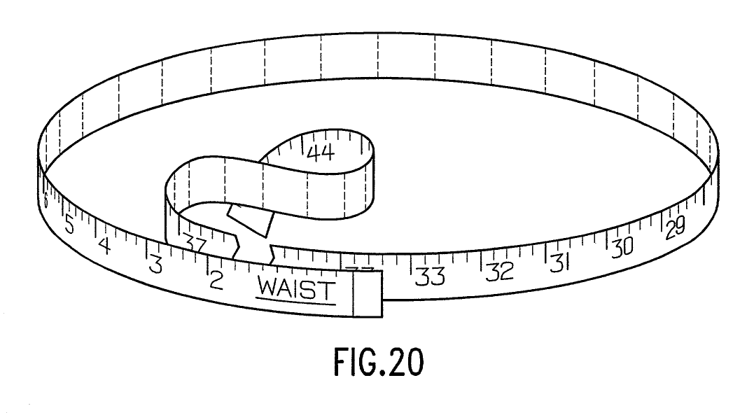

Other embodiments of this invention allow for accurate measurement acquisition without the use of the body suit. Once such embodiment uses an adhesive measuring tape, as shown in FIG. 19. The user simply wraps the tape around the critical body parts identified in FIG. 17. A different tape is provided for each critical body part. For example, to measure the waist, the user selects the tape that corresponds to the waist, then simply wraps the tape around his or her waist. The user can apply the tape directly to his or her skin or alternatively to a form-fitting undergarment. Once the tape is entirely around the user's waist and begins to overlap with the underlying layer of tape, the user simply tears the tape at the measurement closest to the position where the overlap begins, as shown in FIG. 20. The location where the tape is torn indicates the correct measurement of the waist. The tape is preferably perforated at regular intervals to make this process more precise. The user repeats this process for every critical body part, using a different tape for each iteration.

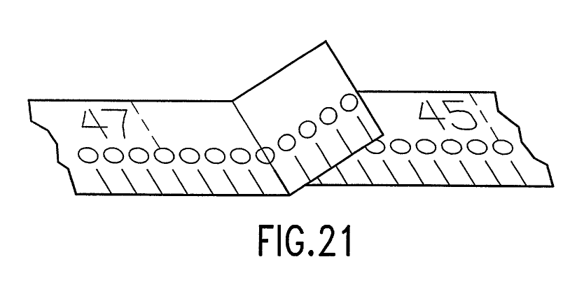

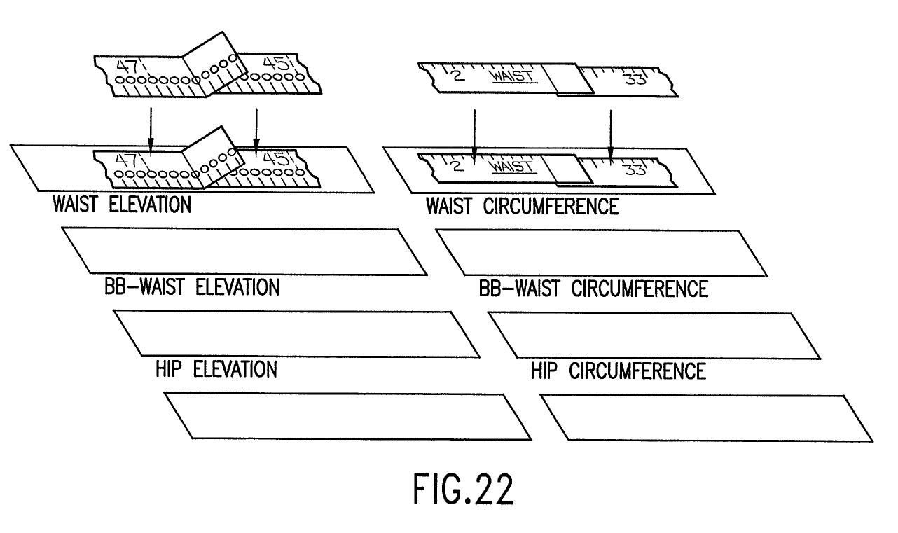

Once the circumferences of the critical body parts are measured but before the tape is removed, the user measures the elevation of each body part. This can be done in the same way that the elevation measurements are acquired if the user was wearing the bodysuit, as discussed previously. Alternatively, different tapes may be provided for each critical elevation. The user would then simply use a different tape for each critical elevation measurement and detach the tape at the correct elevation of each body part, similar to how the user measured the circumferences. Yet another alternative provides the user with an adhesive measuring tape whereby the user simply creases the tape at the critical elevations, as shown in FIG. 21. Once all of the critical circumferences and elevations are measured, the user adheres the tape stubs to the measurement form, making sure to indicate which stub relates to which body part, as shown in FIG. 22. Upon receipt of the sheet, the supplier knows the correct height and elevation measurements of each body part by simply looking at the tape stubs. The supplier can then generate patterns and produce the garments accordingly.

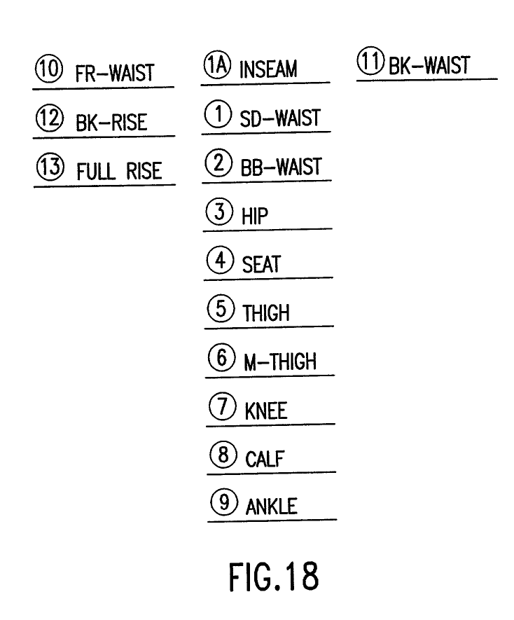

Yet another embodiment not involving the bodysuit provides the user with a number of labels indicating the critical body parts, as shown in FIG. 18. The user positions the labels down the side of his or her body at the appropriate locations as indicated in FIG. 17. The user can then use a measuring tape to take both circumference and elevation measurements.

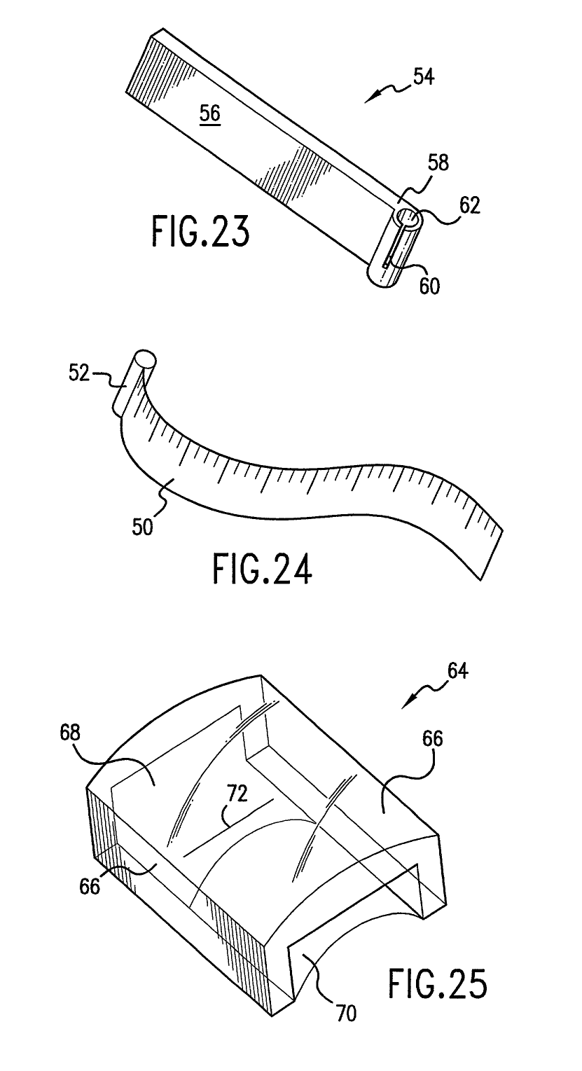

Yet another embodiment of the invention, not necessarily involving the bodysuit, provides an apparatus for acquiring custom measurements of the dimensions of a portion of a human body. The apparatus may have a flexible measuring tape with a nub attached at one end, and a rigid tab removably engageble with the nub. Referring to FIG. 23, rigid tab 54 includes an elongated portion 56 and an engagement portion 58. Rigid tab 54 may be made of plastic, metal, or wood. Of course, any suitable material may be used to make rigid tab 54. A user may step on elongated portion 56 to hold tab 54 in place when taking elevation measurements as described in more detail below. Engagement portion 58 may be formed at one end of elongated portion 56 and may include chamber 62 and slot 60. Referring to FIG. 24, nub 52 may be integrally provided at one end of flexible measuring tape 50. The other end of tape 50 may be formed with a layer (not shown) of suitable material to effect a semi-rigid property of the other end of tape 50. Nub 52 is shaped and sized so as to be insertable into chamber 62 such that tape 50 extends through slot 60. In this manner, tab 54 is removably engageable with tape 50. FIGS. 23-24 illustrate chamber 62 defining a cylinder, and nub 52 formed as a cylinder sized to fit within chamber 62. However, it is recognized that chamber 62 and nub 52 may be in the form of other known corresponding geometric shapes. Moreover, other known releasably engageable structure may be used to form engagement portion 58 and nub 52.

The apparatus for acquiring custom measurements of the dimensions of a portion of a human body may further include a measurement indicator. FIG. 25 illustrates measurement indicator 64 according to an embodiment of the present invention. Indicator 64 may be made of any suitable material, however clear plastic is preferred. Referring to FIG. 25, indicator 64 may include sidewalls 66 and cover portion 68. Hash mark 72 may be scribed on a surface of cover portion 68. Retainer 70 may be made of a flexible material such as plastic and may be attached at base portions of sidewalls 66 and form an arch extending approximately adjacent to a lower surface of cover portion 68. Retainer 70 preferably extends only partially down the length of sidewalls 66 for reasons described below. The semi-rigid end of measuring tape 50 may be inserted between the lower surface of cover portion 68 and the upper surface of retainer 70. The lower surface of cover portion 68 and the upper surface of retainer 70 preferably sandwich tape 50 with an amount of force sufficient to hold indicator 64 in a static manner when a user positions indicator 64 at a desired location along the length of tape 50, yet small enough to allow a dynamic sliding motion of indicator 64 along tape 50. Accordingly, a user may position hash mark 72 of indicator 64 on a marking on tape 50 corresponding to a desired measurement, and read the marking. Preferably, a user may slide indicator 64 along the entire length of tape 50 such that nub 52 is approximately adjacent to retainer 70. Nub 52 contacts retainer 70, prevents indicator 64 from sliding off of tape 50, and aligns a marking labeled “0” on the tape with hash mark 72 of indicator 64.

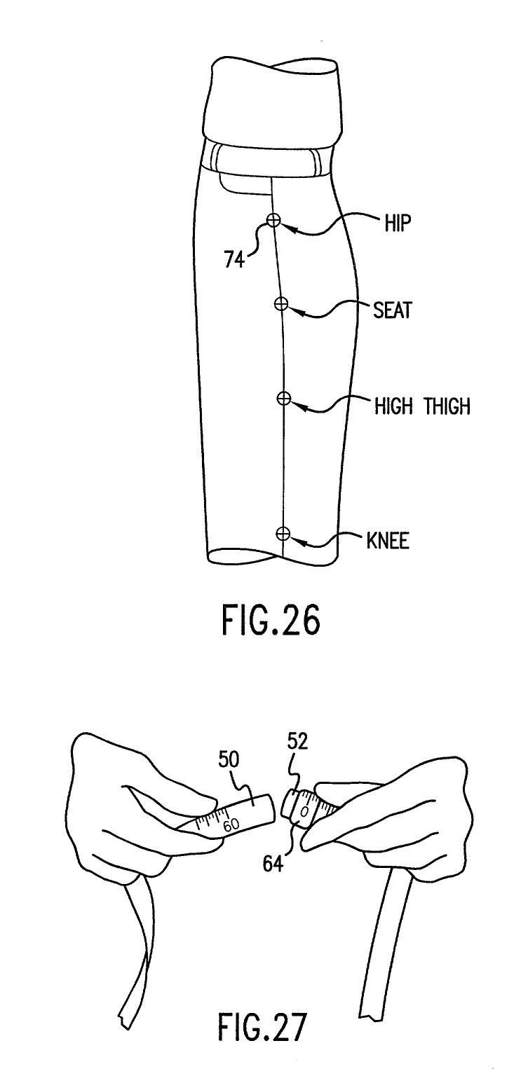

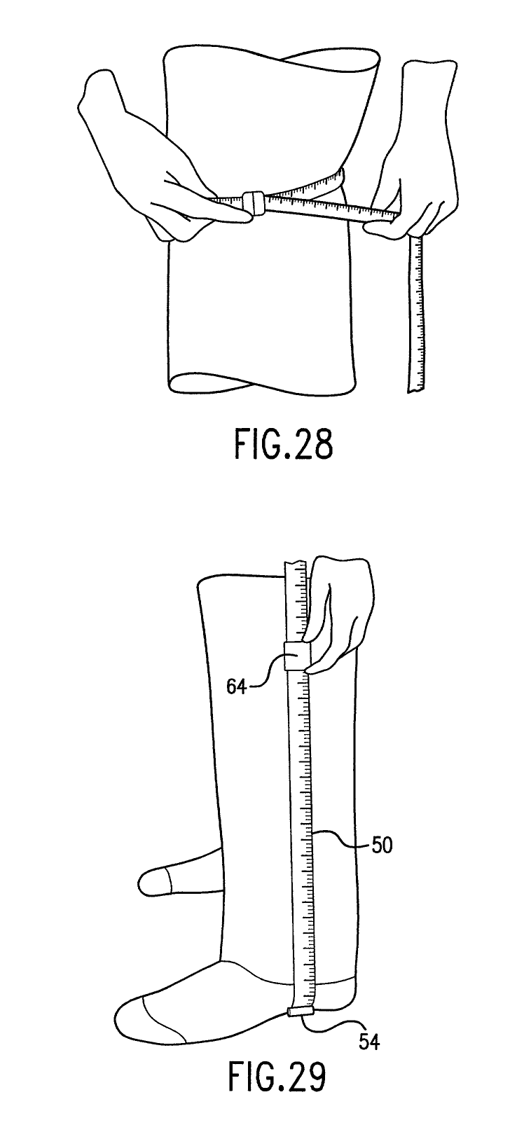

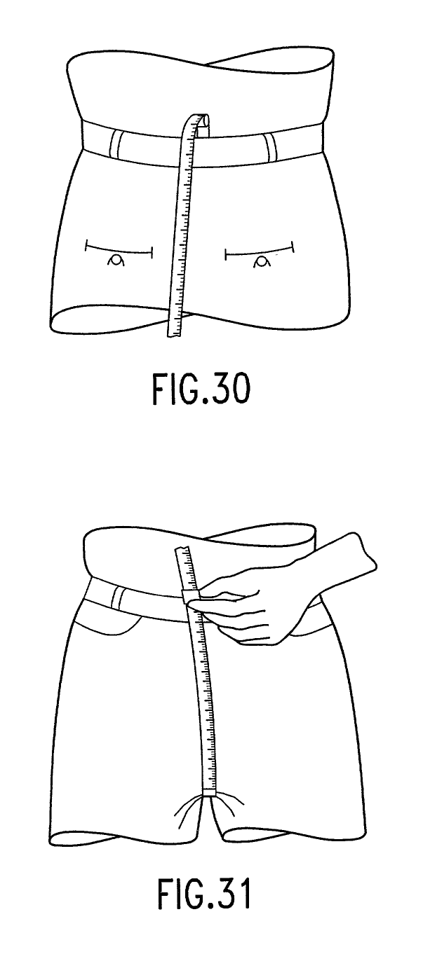

Yet another embodiment of the invention, not necessarily involving the bodysuit, provides a method of acquiring measurements of the dimensions of a portion of a human body using the apparatus for acquiring custom measurements. Referring to FIG. 26, a user may apply markers 74 to a garment or directly to the skin. Markers 74 may be positioned in accordance with a visual display of text or graphics which describes to the user how to properly position markers 74. FIG. 26 illustrates markers 74 positioned at the knee, high thigh, seat and hip. The user may then use the apparatus for acquiring custom measurements to take circumference measurements of portions of a human body at markers 74. Referring to FIG. 27, the user slides indicator 64 along flexible tape 50 until nub 52 is adjacent to retainer 70. Nub 52 contacts retainer 70, prevents indicator 64 from sliding off of tape 50, and aligns a marking labeled “0” on the tape with hash mark 72 of indicator 64. The user may then insert the semi-rigid end of measuring tape 50 between the lower surface of cover portion 68 and an upper surface of tape 50. Referring to FIG. 28, the user may then encompass a portion of the body with tape 50 and pull tape 50 snugly around the portion of the body, while keeping the marking labeled “0” adjacent to hash mark 72. Another marking on tape 50 adjacent to hash mark 72 will indicate the proper circumference measurement which may then be read by the user. Circumference measurements may be taken at several desired locations, and recorded. FIG. 26 illustrates markers positioned for acquiring measurements below the waist. Of course, it is recognized that measurements may also be taken at or above the waist according to principles of the invention.

Next, the user may use the apparatus for acquiring custom measurements to obtain elevation measurements at desired marker locations. Referring to FIG. 29, with nub 52 of tape 50 engaged with chamber 62 of tab 54, the user may step on elongated portion 56, hold tape 50 taut, and position hash mark 72 of indicator 64 on a marking on tape 50 adjacent to a desired marker 74. The user may then read the proper elevation measurement. Elevation measurements may be taken at several desired locations, and recorded.

In addition to circumference and elevation measurments, the use may take rise measurements. Tab 54 allows the user to take the fall or partial rise measurement without assistance. The user simply secures tab 54 into the waistband at the back of his or her pants and pulls the tape between his or her legs up to the front of his or her waist. Of course any number of linear or circumferencial measurements may be taken according to principles of the invention.

Once the dimensions have been recorded, the user may transmit them, via the internet or other known data transmission means, to a central facility, whereupon a computer program at the central facility may create a pattern and direct textile machinery to produce the garment.

Although the foregoing description is directed to the preferred embodiments of the invention, it is noted that other variations and modifications will be apparent to those skilled in the art, and may be made without departing from the spirit or scope of the invention.

What is claimed is:

1. An apparatus for acquiring custom measurements of the dimensions of a portion of a human body comprising:
a flexible measuring tape having a proximal end and a distal end;
a nub attached to the proximal end; and
a rigid tab removably engageable with the nub.

2. The apparatus of claim 1, further comprising a measurement indicator slideably engageable with the measuring tape.

3. The apparatus of claim 2, wherein
the flexible measuring tape comprises graduated markings; and
the measurement indicator is located approximately at a graduated marking labeled 0, when the rigid tab is removed and the indicator is approximately adjacent to the nub.

4. The apparatus of claim 3, wherein the indicator is transparent and includes a hash mark.

5. The apparatus of claim 4, wherein a distal end portion of the tape is rigid.

6. The apparatus of claim 4, wherein the distal end portion is insertable through the indicator for measuring the circumference of the portion of a human body.

7. A method of acquiring measurements of the dimensions of a portion of a human body, using a custom measurement apparatus, said apparatus having a flexible measuring tape with a proximal end and a distal end, a nub attached to the proximal end, and a rigid tab removably engageable with the nub, comprising the steps of:
standing on the rigid tab while measuring the elevation of a portion of the body with the flexible measuring tape;
removing the rigid tab; and
measuring the circumference of the portion of the body with the flexible measuring tape.

8. The method of claim 7, further including the step of entering the elevation and circumference into a database via the internet.

9. The method of claim 7, wherein the measurement apparatus further includes a measurement indicator slideably engageable with the measuring tape, and the step of measuring the circumference of the portion of the body includes the steps of:
sliding the indicator approximately adjacent to the nub so that the indicator is approximately adjacent to a marking of 0 on the measuring tape;
wrapping the measuring tape around the portion of the body; and
inserting the distal end of the measuring tape through the indicator to read a marking on the measuring tape.

10. The method of claim 9, further including the step of entering the elevation and circumference into a database via the internet.

11. The method of claim 10, wherein the steps of measuring the elevation and the circumference further include the step of applying at least one marker to one of the body and an article of clothing on the body.

12. The method of claim 11, further comprising the step of providing a visual display of text or graphics that describes to a user how to properly position the at least one marker.

13. A method of acquiring measurements of the dimensions of a portion of a human body, comprising the steps of:
enclosing the portion in an article of clothing;
positioning benchmarks on the article of clothing at predetermined locations according to a visual display of text or graphics which explains to a user how to properly position the benchmarks; and
measuring a distance between the benchmarks.

14. The method of claim 13, further comprising the step of entering the measured dimension into a database via the internet.

15. The method of claim 13, wherein the benchmarks comprise labels having an adhesive backing.

16. A method of acquiring measurements of the dimensions of a portion of a human body, either with skin exposed or covered by a garment, comprising the steps of.
adhering a measuring device to the skin or garment;
detaching a portion of the measuring device at the location on the measuring device corresponding to the desired measurement; and
adhering the portion of the measuring device to a portion of a measurement form corresponding to the desired measurement.

17. A method of acquiring measurements of the dimensions of a portion of a human body, either with skin exposed or covered by a garment, comprising the steps of
adhering coded labels to the skin or garment with an adhesive backing; and measuring lengths in reference to the labels.
